(19) United States
(12) Patent Application Publication
(10) Pub. No.: US 2025/0286440 A1
(43) Pub. Date: Sep. 11, 2025

(54) STATOR AND MOTOR UNIT INCLUDING SAME

(71) Applicant: MCF Electric Drive Corporation, Hiroshima City (JP)

(72) Inventor: Naoki ITASAKA, Hiroshima City (JP)

(21) Appl. No.: 18/988,249

(22) Filed: Dec. 19, 2024

(30) Foreign Application Priority Data
Mar. 5, 2024 (JP) 2024-033419

(51) Int. Cl. H02K 9/193; H02K 1/20

(52) U.S. Cl. CPC H02K 9/193; H02K 1/20

(57) ABSTRACT

The stator includes a stator core having a circularly cylindrical shape, an oil guide (guide member) having a ring shape and arranged at least on one side in an axial direction of the stator core coaxially with the stator core, and coils attached to the stator core and the oil guide such that a plurality of coil ends of the coils axially protrude from the oil guide. The oil guide includes: an introduction part to which a cooling medium which is externally supplied is introduced; and a plurality of ejection parts which communicate with the introduction part and which are configured to eject the cooling medium toward the coil ends.

### CROSS-REFERENCE TO RELATED APPLICATIONS

The present application is based on JP application No. 2024-33419, filed Mar. 5, 2024, the disclosure of which is incorporated herein by reference in its entirety.

### TECHNICAL FIELD

The present disclosure relates to a stator of a motor and a motor unit including the stator.

### BACKGROUND OF THE DISCLOSURE

Along with recent popularization of electric vehicles, downsizing of a motor is required in terms of mounting of the motor, an increase in types, manufacturing, cost reduction, and the like of the electric vehicles. To downsize the motor without reducing power of the motor, a power density of the motor has to be increased, and more specifically, a current density of a current caused to flow thorough a coil has to be increased. However, when the current density is increased, the amount of heat generation of the coil increases, and therefore, for example, a technique for cooling the coil as disclosed in U.S. Ser. No. 11/462,958 becomes important.

In the technique disclosed in U.S. Ser. No. 11/462,958, however, an externally supplied cooling medium passes through an interior of the stator core and is then ejected toward the coil end. Therefore, the cooling medium which has drawn heat from the stator core and has increased in temperature is ejected onto the coil end. Such a technique disclosed in U.S. Ser. No. 11/462,958 is still susceptible to an improvement in efficiently cooling the coil.

### SUMMARY

In view of the foregoing, it is an object of the present disclosure to provide: a stator configured such that a coil of the stator is efficiently cooled; and motor unit including the stator.

To achieve the object, a stator according to the present disclosure has the following configuration. The stator according to the present disclosure includes: a stator core having a circularly cylindrical shape; a guide member having a ring shape and arranged coaxially with the stator core on at least one side in an axial direction of the stator core; and coils attached to the stator core and the guide member such that a plurality of coil ends of the coils axially protrude from the guide member. The guide member includes: an introduction part to which a cooling medium which is externally supplied is introduced; and a plurality of ejection parts which communicate with the introduction part and which are configured to eject the cooling medium toward the plurality of coil ends.

With this configuration, the coils are attached to the stator core and the guide member such that the plurality of coil ends axially protrude from the guide member, and thereby, the guide member is arranged in the proximity of the coil ends of the coils. Further, since the guide member arranged as described above includes: the introduction part to which the externally supplied cooling medium is introduced; and the plurality of ejection parts which communicate with the introduction part and which are configured to eject the cooling medium toward the coil ends, the externally supplied cooling medium introduced into the introduction part is then ejected as it is toward the coil ends arranged in the proximity. Therefore, the externally supplied cooling medium is applied to the coil ends in a fresh state, a state where the externally supplied cooling medium has not drawn heat from another component of the stator. This provides the effect that the coils can be efficiently cooled.

Further, an accompanying effect is that configuring the guide member as a component separate from the stator core enables the guide member to be provided for the stator without influencing the strength and/or the manufacturability of the stator core.

In the stator, some of the plurality of coil ends may have tilted parts each extending obliquely outward in a direction intersecting the axial direction, and some of the plurality of ejection parts may be configured to eject the cooling medium toward inside parts of the tilted parts, the inside parts facing the guide member. With this configuration, the cooling medium is ejected toward the inside parts facing the guide member, that is, parts in the proximity of the guide member, of the tilted parts of the coil ends. Thus, the cooling medium can reliably be applied to the coil ends.

In the stator, some of the plurality of ejection parts may be configured to eject the cooling medium radially inward from radially outside the plurality of coil ends. With this configuration, the cooling medium is ejected radially inward toward the coil ends located radially inside the ejection parts. In particular, toward the coil ends arranged on a side corresponding to the 6 o'clock side (a lower side) of the guide member, that is, the coil ends located upward of the ejection parts, the cooling medium is ejected upward against the gravity. Thus, the cooling medium can reliably be applied to the coil ends located radially inside the ejection parts.

In the stator, the stator core may have a plurality of first slots each of which axially penetrates the stator core and which are aligned side by side circumferentially, the guide member may have a plurality of second slots each of which axially penetrates the guide member such that the plurality of second slots correspond to the plurality of first slots, the plurality of coil ends may axially protrude from the plurality of second slots when the coils are inserted into the plurality of first slots and the plurality of second slots, and some of the plurality of ejection parts may be arranged between adjacent ones of the plurality of second slots. With this configuration, the ejection parts can be arranged in the proximity of the coil ends, and the cooling medium can be ejected from the proximity of the coil ends, regardless of the radial position of the coil ends of the coils inserted in the plurality of first slots and the plurality of second slots. Thus, the cooling medium can reliably be applied to the coil ends.

In the stator, the plurality of ejection parts may be configured to eject the cooling medium toward respective ones of the coil ends. Thus, the cooling medium can be applied to each of the coil ends, and thus, the entirety of the coils can be more efficiently cooled.

In the stator, the stator core may have an in-core flow path axially penetrating the stator core, and the guide member may have a core connector which communicates with the introduction part and which is connected to an inflow port of the in-core flow path. With this configuration, part of the externally supplied cooling medium is introduced into the introduction part and then flows from the core connector into the in-core flow path. Thus, the stator core can be cooled.

In the stator, the stator core may include a plurality of the guide members arranged on both sides in the axial direction of the stator core, both the guide members may communicate with each other via the in-core flow path such that the cooling medium passes through the in-core flow path from one of the guide members to the other of the guide members, the other guide member may be provided with a plurality of sub-ejection parts configured to eject the cooling medium flowing from the one guide member toward the coil ends in the proximity of the other guide member, that is, the coil ends on the other side. With this configuration, the cooling medium, which has passed through the in-core flow path in the stator core from the one guide member, is ejected from the sub-ejection parts of the other guide member toward the coil end on the other side. Thus, the cooling medium supplied for cooling the stator core can be used without waste to cool the coil ends on the other side.

In the stator, the stator core may have a plurality of first slots each penetrating the stator core in the axial direction, the other guide member may have a plurality of second slots corresponding, one by one, to the plurality of first slots, the coils may be inserted into the plurality of first slots and the plurality of second slots, each of the plurality of sub-ejection parts may be arranged radially outside the second slots of the other guide member, flow paths connected to the plurality of sub-ejection parts may have openings which are open toward the plurality of second slots. With this configuration, the coils inserted through the second slots face the flow paths via the openings, thereby increasing contact area between the cooling medium and the coils. Thus, the coils can be more efficiently cooled.

In the stator, the guide member may have a chamber including an annular part which is concentric, and the plurality of ejection parts may communicate with the introduction part via the chamber. With this configuration, the cooling medium in the chamber can be ejected from the ejection parts in the state where the annular part is uniformly filled in the circumferential direction with the cooling medium introduced to the introduction part. This enables the cooling medium to be circumferentially uniformly ejected from the ejection parts, and thus, the cooling medium can be circumferentially uniformly applied to each of the coil ends.

In the stator, the guide member may be provided with a peripheral wall continuously surrounding the annular part from radially outside. With this configuration, a space radially outside the annular part is occupied by the peripheral wall, thereby reducing the volume of the flow path in the guide member. This can suppress air from accumulating in the guide member, thereby suppressing the ejection pressure of the cooling medium from the guide member from decreasing.

In the stator, the chamber may include a plurality of branches branched radially inward from the annular part, and the branches may have ends connected to the plurality of ejection parts. When the chamber includes the branches, this configuration eliminates a space in each branch between an end side and its part connected to a corresponding one of the ejection parts. This can suppress air from accumulating at the ends of the branches, thereby suppressing the ejection pressure of the cooling medium from the guide member from decreasing.

In the stator, the guide member may be made of non-magnetic material. This enables the guide member to be provided for the stator without magnetically influencing the motor.

In the stator, the guide member may be made of resin material. Thus, the degree of freedom of processing the guide member can be increased, and thus, the ejection part can be freely arranged depending on the arrangement of the coil ends.

The stator may include a sub-guide member arranged axially outside the guide member, being coaxial with the guide member, and having a cylindrical shape, the introduction part of the guide member may be open radially outward, and the sub-guide member may have an outer circumference part having a guide groove configured to receive the externally supplied cooling medium and guide the cooling medium to the introduction part. With this configuration, the externally supplied cooling medium is guided along the guide groove in the outer circumference part of the sub-guide member to the introduction part of the guide member. Thus, without increasing the size of the stator radially outward beyond the guide member, the externally supplied cooling medium can be guided to the introduction part, and thus, the cooling medium can be introduced to the introduction part with a simple and space-saving structure.

Moreover, a motor unit according to the present disclosure is a motor unit including: a motor including the stator; and a housing in which the stator is housed, and the housing is configured to press the guide member of the stator axially against the stator core. With this configuration, the cooling medium is suppressed from leaking from a location between the stator core and the guide member without providing a sealing member, such as an O-ring, between the stator core and the guide member. Thus, the number of components included in the motor unit can be reduced, and thus, the cost of the motor unit can be reduced.

As described above, the present disclosure enables the coils to be efficiently cooled.

### BRIEF DESCRIPTION OF THE DRAWINGS

FIG. 1 is a schematic longitudinal sectional view of part of a motor unit of a first embodiment;

FIG. 2 is a perspective view of a stator of the first embodiment;

FIG. 3 is an exploded perspective view of the stator of FIG. 2;

FIG. 4 is an enlarged view of coil ends;

FIG. 5 is a schematic front view of part of an oil guide of the first embodiment;

FIG. 6 is a schematic perspective view of part of the oil guide of FIG. 5 viewed from an axially inner side;

FIG. 7 is a view illustrating a first flow pattern;

FIG. 8 is a view illustrating a flow of oil in the oil guide in the first flow pattern;

FIG. 9 is a view illustrating a second flow pattern;

FIG. 10 is a view illustrating a flow of oil in a front oil guide in the second flow pattern;

FIG. 11 is a view illustrating a flow of the oil in a rear oil guide in the second flow pattern;

FIG. 12 is a view illustrating a third flow pattern;

FIG. 13 is a view illustrating a flow of oil in the front oil guide in the third flow pattern;

FIG. 14 is a view illustrating a flow of the oil in the rear oil guide in the third flow pattern;

FIG. 15 is a view for explaining an ejection manner of ejection parts and sub-ejection parts;

FIG. 16 is an enlarged view of ejection parts on a radially outside and coil ends which are ejection targets of the ejection parts on the radially outside;

FIG. 17 is an enlarged view of ejection parts on a radially inside and coil ends which are ejection targets of the ejection parts on the radially inside;

FIG. 18 is an enlarged view of the sub-ejection parts and coil ends which are ejection targets of the sub-ejection parts;

FIG. 19 is a schematic longitudinal sectional view of a coil end arranged on a lower side of the oil guide and a peripheral part of the coil end;

FIG. 20 is a schematic front view of an oil guide of a second embodiment;

FIG. 21 is an enlarged view of an upper part of the oil guide of FIG. 20; and

FIG. 22 is a schematic longitudinal sectional view of a flow path leading to a sub-ejection part of the second embodiment.

### DETAILED DESCRIPTION

Embodiments of the present disclosure will be described with reference to the drawings below.

### First Embodiment

### Configuration of Motor Unit

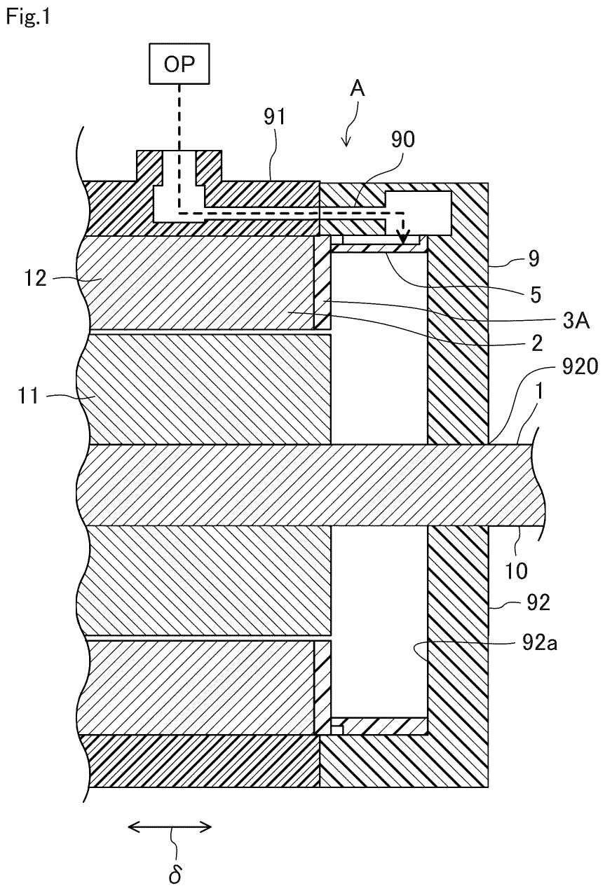

FIG. 1 is a schematic longitudinal sectional view of part of a motor unit A of a first embodiment. Note that FIG. 1 shows one end in an axial direction of the motor unit A, and the other end in the axial direction appears in a similar manner. First of all, the configuration of the motor unit A according to the first embodiment of the present disclosure will be described. As shown in FIG. 1, the motor unit A includes a motor 1 and a housing 9.

The motor 1 is, for example, an interior permanent magnet motor (IPM motor) and is used as a driving source of an electric vehicle. The motor 1 includes: a shaft 10 which constitutes a rotational axis; a rotor 11 having a circularly cylindrical shape with a center hole in which the shaft 10 is fixed; and a stator 12 having a circularly cylindrical shape and arranged radially spaced apart from the rotor 11 such that an inner circumferential surface of the stator 12 faces an outer circumferential surface of the rotor 11. The shaft 10 is rotatable together with the rotor 11 and relative to the stator 12. The shaft 10, the rotor 11, and the stator 12 are arranged concentrically with one another, and axial directions thereof are collectively denoted by 6 in the figures. The configuration of the stator 12 will be described in detail later.

The motor 1 is supplied with oil as a cooling medium. More specifically, oil stored in an oil pan (not shown) and cooled by a heat exchanger (not shown) is pumped by an oil pump OP to the motor 1. In FIG. 1, a bold dashed arrow conceptually shows a flow of the oil, and likewise, bold arrows and bold dashed arrows in the following figures show flows of the oil. After used to cool the motor 1, the oil is stored in the oil pan again.

The housing 9 houses the rotor 11 and the stator 12 while exposing both ends of the shaft 10. The housing 9 has a flow path 90 formed therein. Through the flow path 90, externally supplied oil flows to the motor 1. The housing 9 may have another flow path (omitted in the figure) for the oil, for example, a flow path through which the oil flows to another member (e.g., a bearing). The configuration of the housing 9 will be described in detail later.

### Configuration of Stator

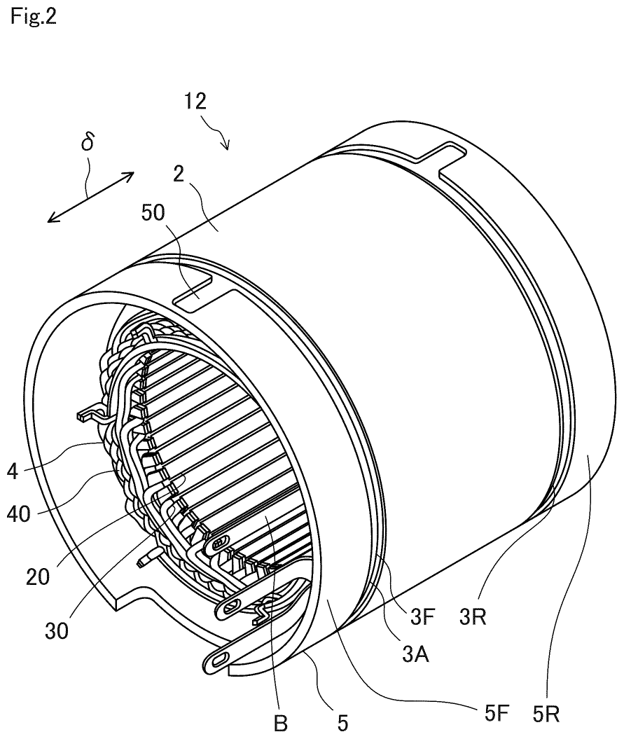

FIG. 2 is a perspective view of the stator 12 of the first embodiment. Subsequently, the configuration of the stator 12 according to the first embodiment of the present disclosure will be described in detail. As shown in FIG. 2, the stator 12 includes a stator core 2, an oil guide 3A (a guide member), coils 4 each having a plurality of coil ends 40 at axial ends thereof, and a sub-oil guide 5 (sub-guide member). The stator 12 is configured to allow a current to flow from a power supply (not shown) via an input terminal B to the coils 4, and the coils 4 serve as a main heat generation source of the stator 12. Thus, to cool mainly the coils 4, the stator 12 is configured to eject the oil flowing from the flow path 90 of the housing 9 toward the coil ends 40 of the coils 4 by using the oil guide 3A. Each of the components of the stator 12 is first described below, and then, the detailed configuration of the oil guide 3A will be described together with flow patterns of the oil.

### Each Component of Stator

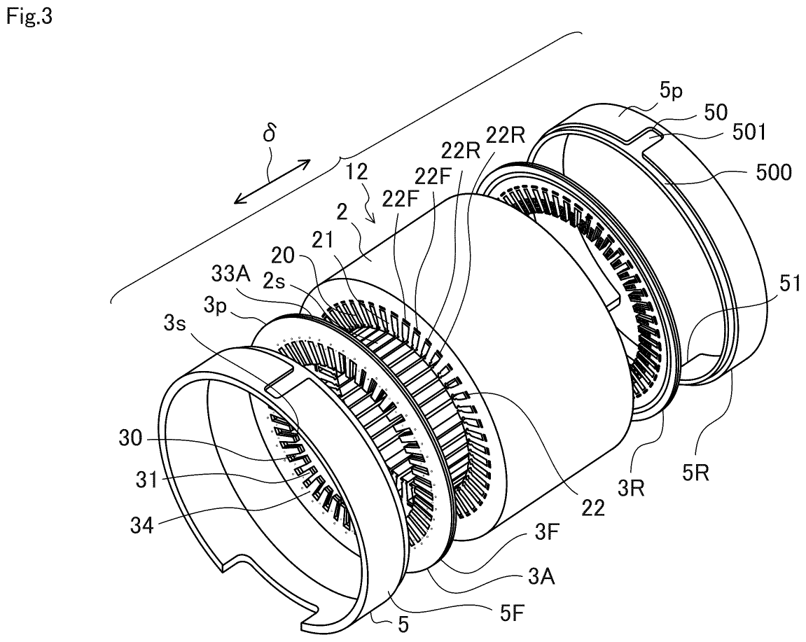

FIG. 3 is an exploded perspective view of the stator 12 of FIG. 2. Note that in FIG. 3, the coils 4 are not shown for the sake of illustration. As shown in FIG. 3, the stator core 2 has a circularly cylindrical shape and is made of magnetic material such as magnetic steel. The stator core 2 includes a plurality of first teeth 21 formed over the entire axial length of the stator core 2. The plurality of first teeth 21 extend circumferentially inward and are aligned side by side circumferentially. A space between adjacent ones of the plurality of first teeth 21 is a first slot 20. Thus, the stator core 2 has a plurality of first slots 20 axially penetrating the stator core 2 and disposed side by side circumferentially. Each first slot 20 extends radially outward from an inner circumference part 2s of the stator core 2 to open radially inward.

As shown in FIG. 3, the stator core 2 further has a plurality of in-core flow paths 22 each formed radially outside a corresponding one of the first slots 20 and axially penetrating the stator core 2. Each in-core flow path 22 has a substantially rectangular cross-sectional surface orthogonal to the axial direction and has a circumferential width set to correspond to a circumferential width of the corresponding one of the first slots 20.

The in-core flow paths 22 include in-core flow paths 22F through which the oil flows axially forward and in-core flow paths 22R through which the oil flows axially rearward. The in-core flow paths 22F and 22R are alternately arranged, two by two, circumferentially. For the sake of description, matters common to the in-core flow paths 22F and 22R may be described hereinafter by using common reference numeral 22. The flow patterns of the oil passing through the in-core flow path 22 will be described later together with flow patterns of the oil passing through the oil guide 3A.

As shown in FIGS. 2 and 3, the oil guide 3A includes an oil guide 3F and an oil guide 3R arranged on both sides in the axial direction of the stator core 2. The oil guide 3F is arranged on one side, i.e., on a front side, in the axial direction of the stator core 2. The oil guide 3R is arranged on the axially other end side, i.e., on a rear side, of the stator core 2. The oil guides 3F and 3R each have a ring shape having substantially the same outer diameter and inner diameter as those of the stator core 2 and are each arranged coaxially with the stator core 2. Both the oil guides 3F and 3R communicate via the in-core flow paths 22 with each other such that the oil passes through the in-core flow paths 22 of the stator core 2 from one of the oil guides to the other of the oil guides.

The oil guides 3F and 3R are arranged to face away from each other and have the same shape. Therefore, for the sake of description, matters common to the oil guides 3F and 3R may be described hereinafter by using common reference character 3A.

The oil guide 3A is made of non-magnetic material, more specifically, resin material (e.g., syndiotactic polystyrene (SPS), polyphenylene sulfide (PPS)). As shown in FIG. 3, the oil guide 3A includes a plurality of second teeth 31 formed over the entire axial length of the oil guide 3A. The plurality of second teeth 31 extend circumferentially inward to correspond one by one to the plurality of first teeth 21 of the stator core 2 and are aligned side by side circumferentially. A space between adjacent ones of the plurality of second teeth 31 is a second slot 30. Thus, the oil guide 3A has a plurality of second slots 30 axially penetrating the oil guide 3A to correspond one by one to the plurality of first slots 20. Each second slot 30 extends radially outward from an inner circumference part 3s of the oil guide 3A to open radially inward.

Referring back to FIG. 2, the coils 4 are so-called segment conductor (SC) windings including a plurality of segment coils connected to each other. Although not shown, the coils 4 are included in a plurality of (in the present embodiment, three) coil groups (corresponding to three phases) through which currents with different phases flow, and each coil 4 has an outer surface covered with an insulation coating.

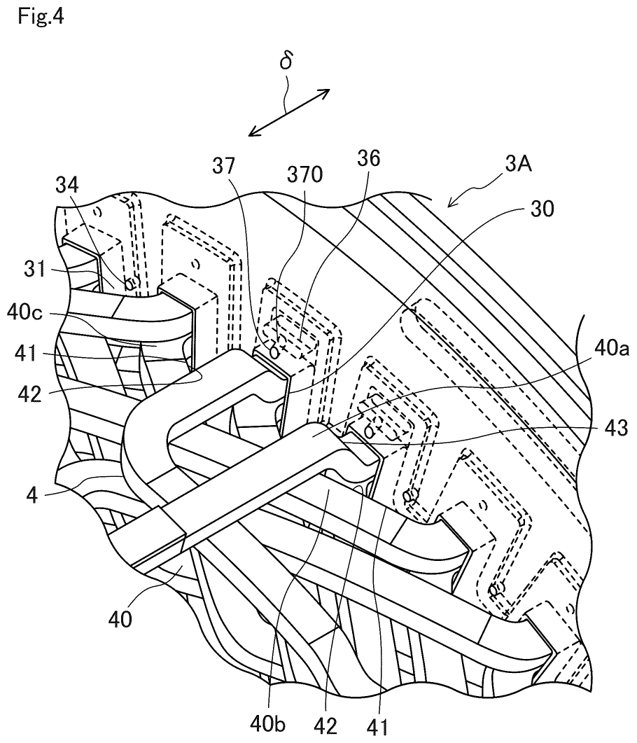

FIG. 4 is an enlarged view of the coil ends 40. As shown in FIG. 2, the coils 4 are attached to the stator core 2 and the oil guide 3A such that the plurality of coil ends 40 axially protrude from the oil guide 3A. More specifically, the coils 4 are inserted into the plurality of first slots 20 of the stator core 2 and the plurality of second slots 30 of the oil guide 3A. Thus, the coil ends 40 axially protrude from the second slots 30 as shown in FIG. 4. The coils 4 are thus attached to the stator core 2 and the oil guide 3A, and thereby, the oil guide 3A is arranged in the proximity of the coil ends 40 of the coils 4.

The arrangement and the shape of each coil end 40 depend on the orientation (extension direction) of a corresponding one of the coils 4. As an example, some (coil ends 40a, 40b, and 40c) of the coil ends 40 shown in FIG. 4 will be described. Note that in FIG. 4, the coil ends 40a, 40b, and 40c arranged on an upper side are shown, and these coil ends 40a, 40b, and 40c are repeatedly arranged over the entire circumference.

As shown in FIG. 4, the coil ends 40a, 40b, and 40c are arranged to overlap each other in this order radially from outside to inside. Each of the coil end 40b and the coil end 40c overlapped radially inside by the coil end 40b has a tilted part 41 extending obliquely outward in a direction intersecting the axial direction in accordance with the orientation of a corresponding one of the coils 4. An inside part 42 in the axial direction of the tilted part 41 faces the oil guide 3A. Further, the coil end 40a has a step part 43 which rises radially outward by one step so as not to interfere with the coil end 40b which is radially inward of and overlapping the coil end 40a. Thus, the coil ends 40 are variously arranged and have various shapes so as not to interfere with each other while the coil ends 40 are in accordance with the orientations of the respective coils 4.

Referring back to FIGS. 2 and 3, the sub-oil guide 5 includes a sub-oil guide 5F and a sub-oil guide 5R which are arranged axially outside the oil guide 3A. The sub-oil guide 5F is arranged forward of the oil guide 3F. The sub-oil guide 5R is arranged rearward of the oil guide 3R. The sub-oil guides 5F and 5R each have a cylindrical shape and are arranged coaxially with the oil guides 3F and 3R.

The sub-oil guides 5F and 5R are arranged to face away from each other and have the same shape. Therefore, for the sake of description, matters common to the sub-oil guides 5F and 5R may be described hereinafter by using common reference numeral 5.

The sub-oil guide 5 is made of non-magnetic material, more specifically, resin material (e.g., syndiotactic polystyrene (SPS), polyphenylene sulfide (PPS)). The sub-oil guide 5 has an outer circumference part 5p having a guide groove 50 and a cutout 51. The guide groove 50 is configured to receive the externally supplied oil and guide the oil to the oil guide 3A. The cutout 51 is configured to discharge the oil, which has been used to cool the coil ends 40, from the stator 12.

As shown in FIG. 3, the guide groove 50 includes a circularly annular groove 500 and a straight groove 501. The circularly annular groove 500 has an axially inner end which lowers radially inward by one step toward the oil guide 3A. The straight groove 501 extends axially outward from an upper part of the annular groove 500. The oil flowing from the flow path 90 of the housing 9 in FIG. 1 is dropped onto the straight groove 501 and then flows from the circularly annular groove 500 to the oil guide 3A (specifically, an introduction part 33A which will be described in detail later), and the oil is used to cool the coil 4 and is then discharged from an inner circumference side of the sub-oil guide 5 through the cutout 51.

### Configuration of Oil Guide

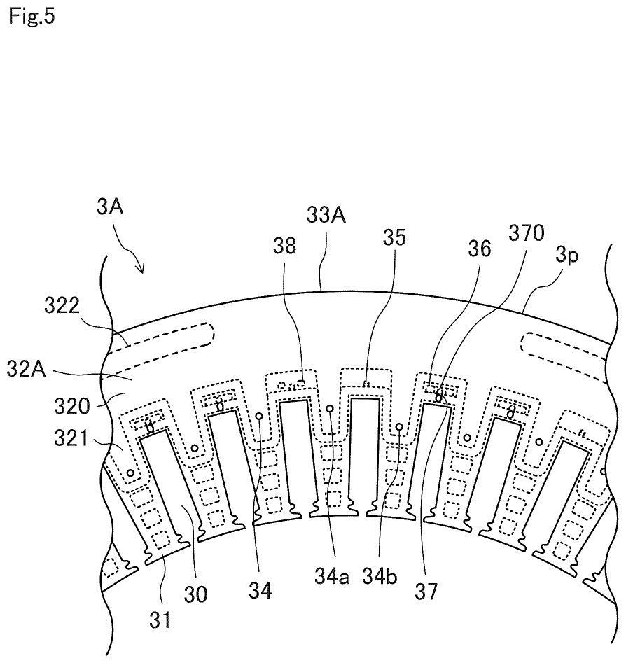

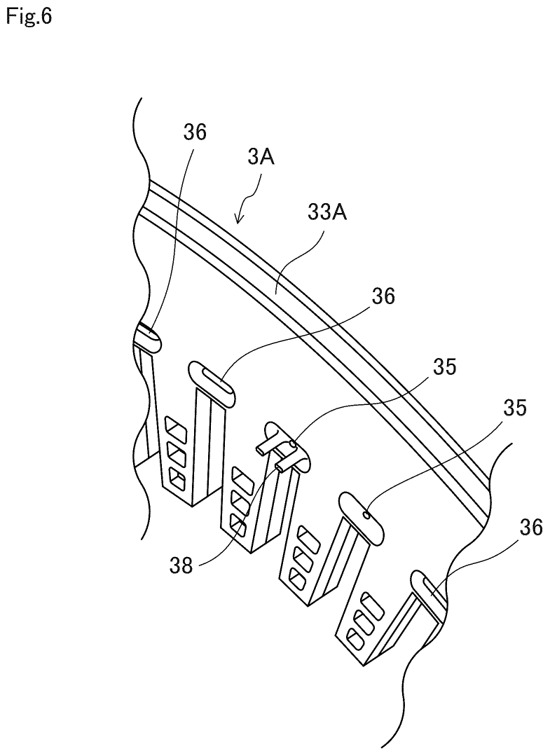

FIG. 5 is a schematic front view of part of the oil guide 3A of the first embodiment. FIG. 6 is a schematic perspective view of the part of the oil guide 3A of FIG. 5 viewed from an axially inner side. Then, the detailed configuration of the oil guide 3A will be described together with the flow patterns of the oil passing through the oil guide 3A.

As shown in FIGS. 5 and 6, the oil guide 3A includes, in addition to a chamber 32A as an interior space and the introduction part 33A to which the externally supplied oil is introduced, a plurality of ejection parts 34, a plurality of first connectors 35 (core connectors), a plurality of second connectors 36, and a plurality of sub-ejection parts 37. Each ejection part 34 communicates via the chamber 32A with the introduction part 33A and is configured to eject the oil toward the coil end 40. Each first connector 35 communicates via the chamber 32A with the introduction part 33A and is connected to an inflow port of the in-core flow path 22, and each second connector 36 is connected to an outlet port of the in-core flow path 22 in the stator core 2. Each sub-ejection part 37 communicates with a corresponding one of the second connectors 36 and is configured to eject the oil flowing from another oil guide 3A toward the coil end 40. The flow patterns of the oil passing through the oil guide 3A including these components are classified into the following three patterns.

### Flow Pattern of Oil

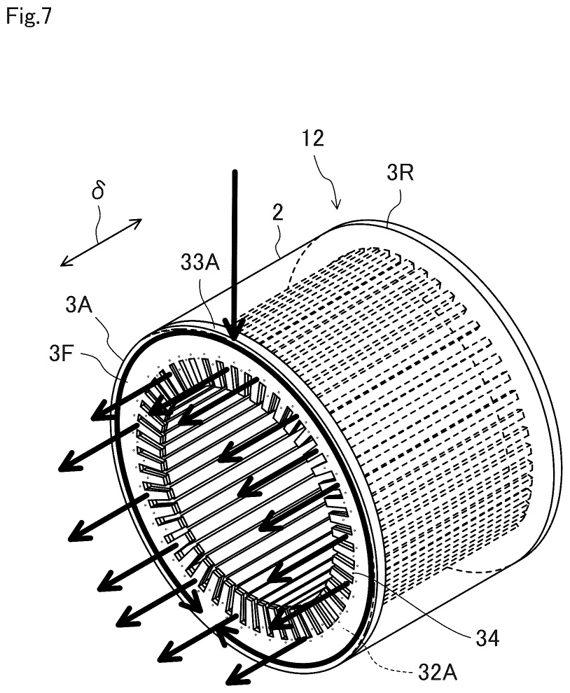

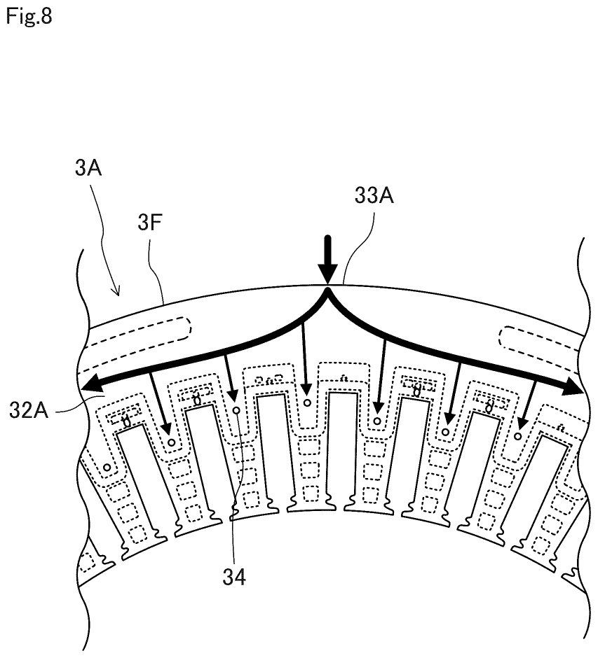

FIG. 7 is a view illustrating a first flow pattern. Note that in FIG. 7, the coils 4 are not shown for the sake of illustration. FIG. 8 is a view illustrating a flow of oil in the oil guide 3A in the first flow pattern. As shown in FIG. 7, the first flow pattern is a pattern of the flow of the oil through the same oil guide 3A, and as shown in FIG. 8, the externally supplied oil is introduced to the introduction part 33A of the oil guide 3A and then passes through the chamber 32A, and the ejection parts 34 of the same oil guide 3A eject the oil toward the coil ends 40 in the proximity thereof. Note that FIGS. 7 and 8 show the flow of the oil in the front oil guide 3F, and the flow of the oil in the rear oil guide 3R is the same as that in the front oil guide 3F except that the direction of the oil ejected from the ejection parts 34 is opposite to the direction (facing the viewer) shown in FIG. 7.

In the first flow pattern as described above, the externally supplied oil introduced to the introduction part 33A by the introduction part 33A and the ejection parts 34 of the oil guide 3A is then ejected as it is from the ejection parts 34 toward the coil ends 40 in the proximity of the ejection parts 34. Therefore, the externally supplied oil is ejected onto the coil ends 40 in a fresh state, a state where the externally supplied oil has not drawn heat from another component (e.g., the stator core 2) of the stator 12. Thus, the coils 4 can be efficiently cooled.

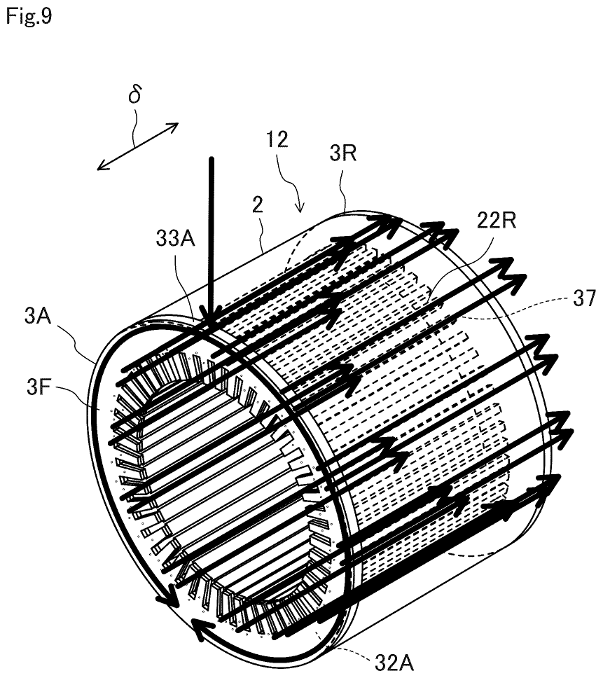

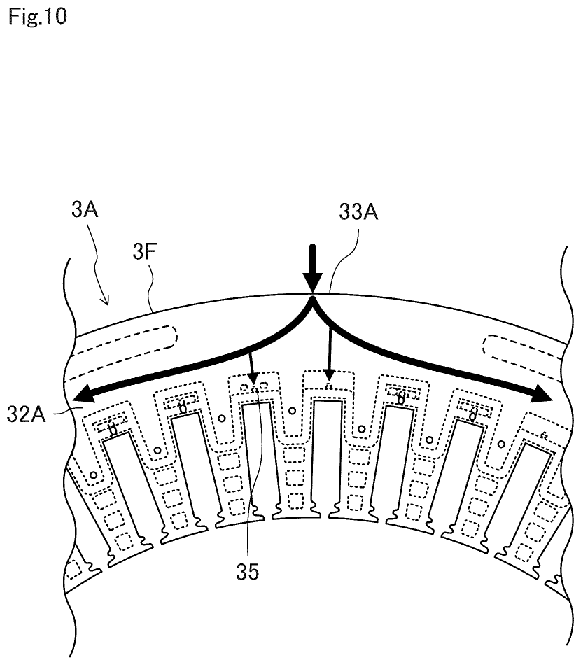

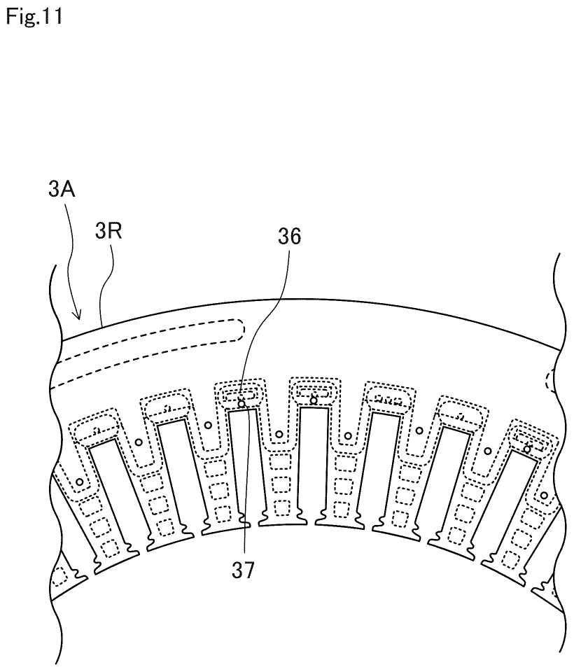

FIG. 9 is a view illustrating a second flow pattern. Note that in FIG. 9, the coils 4 are not shown for the sake of illustration, and the first connectors 35 and the second connectors 36 do not appear. FIG. 10 is a view illustrating a flow of oil in the front oil guide 3F in the second flow pattern. FIG. 11 is a view illustrating a flow of oil in the rear oil guide 3R in the second flow pattern. As shown in FIG. 9, the second flow pattern is a pattern of oil flowing from the front oil guide 3F to the rear oil guide 3R. More specifically, in the second flow pattern, the externally supplied oil is introduced to the introduction part 33A of the front oil guide 3F as shown in FIGS. 9 and 10, then passes through the chamber 32A and the first connectors 35 of the oil guide 3F as shown in FIG. 10, and passes the in-core flow paths 22R of the stator core 2 as shown in FIG. 9. Then, the externally supplied oil further passes through the second connectors 36 in the rear oil guide 3R as shown in FIGS. 9 and 11 and is ejected from the sub-ejection parts 37 of the oil guide 3R toward the coil ends 40 on the rear side.

In the second flow pattern as described above, the first connectors 35 of the front oil guide 3F allow part of the externally supplied oil introduced to the introduction part 33A of the oil guide 3F to flow from the first connectors 35 into the in-core flow paths 22R of the stator core 2. Thus, the stator core 2 can be cooled.

Further, in the second flow pattern, the sub-ejection parts 37 of the rear oil guide 3R eject the oil passing from the oil guide 3F through the in-core flow paths 22R of the stator core 2 toward the coil ends 40 on the rear side. This enables the oil supplied for cooling the stator core 2 to be used without waste to cool the coil ends 40 on the rear side.

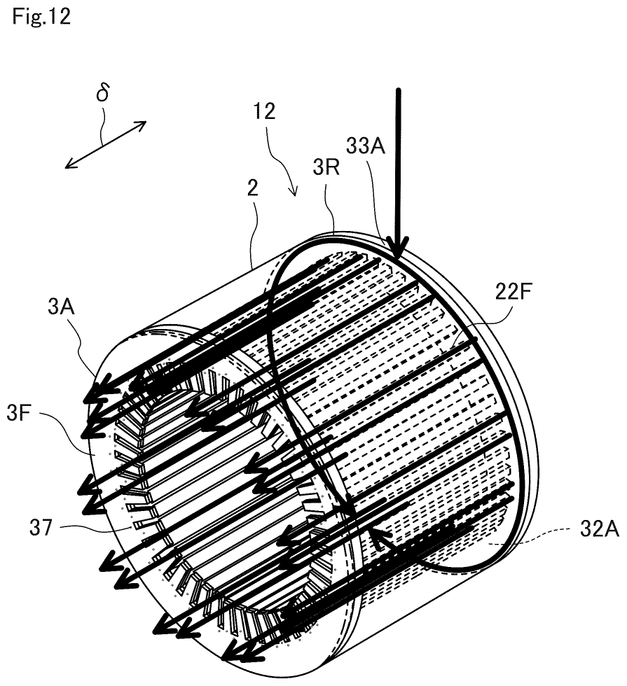

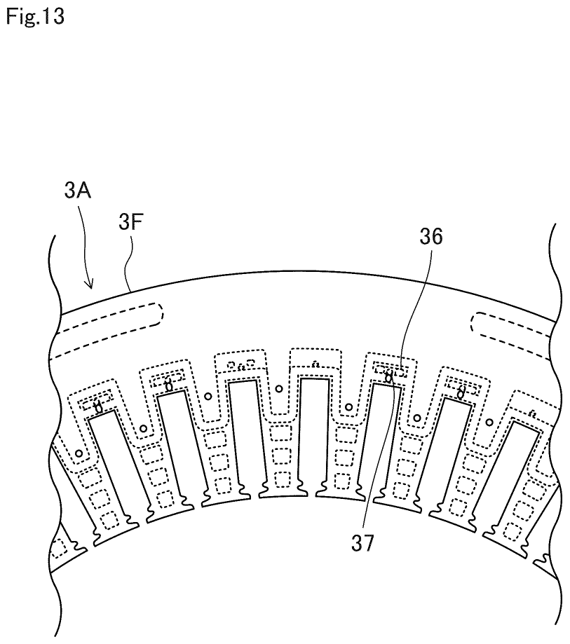

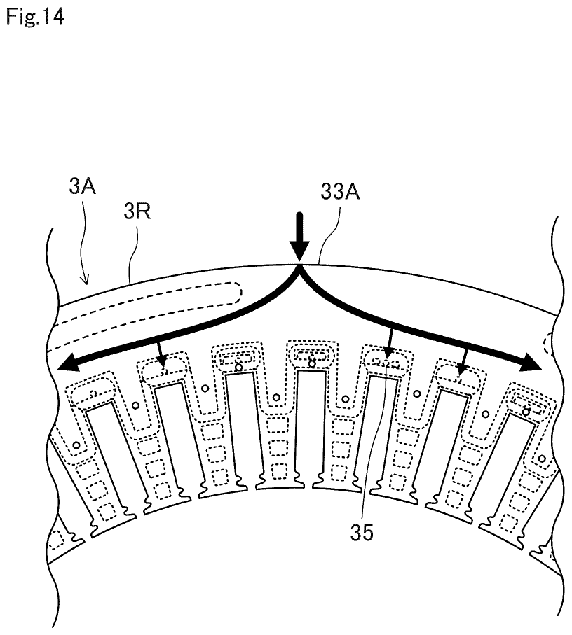

FIG. 12 is a view illustrating a third flow pattern. Note that in FIG. 12, the coils 4 are not shown for the sake of illustration, and the first connectors 35 and the second connectors 36 do not appear. FIG. 13 is a view illustrating a flow of oil in the front oil guide 3F in the third flow pattern. FIG. 14 is a view illustrating a flow of oil in the rear oil guide 3R in the third flow pattern. As shown in FIG. 12, the third flow pattern is a pattern of oil flowing from the rear oil guide 3R to the front oil guide 3F in contrast to the second flow pattern described above. More specifically, in the third flow pattern, the externally supplied oil is introduced to the introduction part 33A of the rear oil guide 3R as shown in FIGS. 12 and 14, then passes through the chamber 32A and the first connectors 35 of the oil guide 3R as shown in FIG. 14, passes through the in-core flow paths 22F of the stator core 2 as shown in FIG. 12, further passes through the second connectors 36 of the front oil guide 3F as shown in FIGS. 12 and 13, and is ejected from the sub-ejection parts 37 of the oil guide 3F toward the coil ends 40 on the front side.

Similarly to the second flow pattern, such a third flow pattern allows part of the externally supplied oil to flow from the first connectors 35 of the oil guide 3R into the in-core flow paths 22F of the stator core 2, thereby cooling the stator core 2. Further, the oil passing through the in-core flow paths 22F is ejected from the sub-ejection parts 37 of the oil guide 3F toward the coil ends 40 on the front side, and thereby, the oil supplied for cooling the stator core 2 is used without waste to cool the coil ends 40 on the front side.

Components of the oil guide 3A implementing the flow patterns are configured as described below in detail.

### Details of Components of Oil Guide

Referring back to FIG. 5, the chamber 32A includes an annular part 320 and a plurality of branches 321. The annular part 320 is arranged to surround the second slots 30 from radially outside and is concentric. The plurality of branches 321 branch radially inward from the annular part 320 toward the interior of the second teeth 31. Each branch 321 is connected to a corresponding one of the ejection parts 34, and therefore, the chamber 32A is connected to the ejection parts 34 at the respective branches 321. In the annular part 320, a plurality of spacers 322 having an axial thickness are circumferentially provided with a space therebetween. This can suppress the chamber 32A from being axially compressed, that is, the oil guide 3A from axially deforming.

Further, as described above, the ejection parts 34 communicate via the chamber 32A including the annular part 320 with the introduction part 33A, and thereby, the oil in the chamber 32A can be ejected from the ejection parts 34 in the state where the annular part 320 is uniformly filled in the circumferential direction with the oil introduced to the introduction part 33A. This enables the oil to be circumferentially uniformly ejected from the ejection parts 34, and thus, the oil can be circumferentially uniformly applied to each of the coil ends 40.

As shown in FIG. 3, the introduction part 33A is open radially outward over the entire circumference of an outer circumference part 3p of the oil guide 3A. Thus, the oil can be introduced into the oil guide 3A from the entire circumference of the outer circumference part 3p of the oil guide 3A.

As shown in FIGS. 4 and 5, the ejection parts 34 are each a circular hole open axially outward and are provided in an axially outer part of the oil guide 3A. The ejection parts 34 are circumferentially arranged spaced apart from each other. As shown in FIG. 4, the ejection parts 34 are arranged in the proximity of the coil ends 40. This enables the oil to be reliably applied to the coil ends 40.

Further, as shown in FIG. 5, the ejection parts 34 are arranged on the second teeth 31, that is, are each arranged between adjacent ones of the second slots 30 and include ejection parts 34a arranged radially outside and ejection parts 34b arranged radially inside. The ejection parts 34a and the ejection parts 34b are arranged on the respective second teeth 31 such that the ejection parts 34a and the ejection parts 34b are circumferentially aligned two by two alternately. The ejection parts 34 are thus each arranged between adjacent ones of the second slots 30, and thereby, regardless of the radial position of the coil ends 40 of the coils 4 inserted into the first slots 20 and the second slots 30, for example, the ejection parts 34 can be arranged in the proximity of the coil ends 40 such that the ejection parts 34b are arranged in the proximity of the coil ends 40 arranged radially inside, and the oil can be ejected from the proximity of the coil ends 40. This enables the oil to be reliably applied to the coil ends 40.

As shown in FIGS. 5 and 6, the first connectors 35 are each a circular hole open axially inward and are provided in an axially inner part of the oil guide 3A. The first connectors 35 of the front oil guide 3F are connected to the inflow ports of the in-core flow paths 22R, and likewise, the first connectors 35 of the rear oil guide 3R are connected to the inflow ports of the in-core flow paths 22F. Therefore, each first connector 35 is arranged at a circumferential position and a radial position corresponding to the inflow port of an associated one of the in-core flow paths 22. The opening area of each first connector 35 is set to be smaller than the opening area of the inflow port of the associated one of the in-core flow paths 22. Thus, the inflow pressure of the oil to the in-core flow paths 22 can be increased.

Also shown in FIGS. 5 and 6, the second connectors 36 are each an elongated hole which is open axially inward and which has a circumferential length corresponding to the circumferential width of the outlet port of a corresponding one of the in-core flow paths 22, and each second connector 36 is provided in the axially inner part of the oil guide 3A. The second connectors 36 of the front oil guide 3F are connected to the outflow ports of the in-core flow paths 22F, and likewise, the second connectors 36 in the rear oil guide 3R are connected to the outflow ports of the in-core flow paths 22R. Thus, each second connector 36 is arranged at a circumferential position and a radial position corresponding to the outflow port of an associated one of the in-core flow paths 22. The opening area of each second connector 36 is set to be substantially equal to the opening area of the outlet port of the associated one of the in-core flow paths 22. As shown in FIG. 6, the first connectors 35 and the second connectors 36 are circumferentially arranged two by two alternately corresponding to the alignment of the in-core flow paths 22F and 22R.

As shown in FIGS. 4 and 5, the sub-ejection parts 37 are each a circular hole open axially outward and are provided in an axially outer part of the oil guide 3A. The sub-ejection parts 37 are circumferentially arranged spaced apart from each other at circumferential positions corresponding to the second connectors 36 and radially outside the second slots 30. Each sub-ejection part 37 has a smaller opening area than a corresponding one of the second connectors 36 and is connected via a flow path 370 to the corresponding one of the second connectors 36. The flow path 370 has a cross-sectional area which is orthogonal to its extension direction (in the present embodiment, the axial direction) and which gradually decreases from the second connector 36 toward the sub-ejection part 37. This enables the outflow pressure of the oil from the sub-ejection part 37 to be increased.

Note that similarly to the flow path 370 connected to the sub-ejection part 37, flow paths each connected to a corresponding one of the ejection parts 34 (flow paths each leading to a corresponding one of the ejection parts 34 and the chamber 32A) may have a cross-sectional area which is orthogonal to its extension direction and which gradually decreases from the chamber 32A toward the corresponding one of the ejection parts 34. Similarly to the above-described case, this enables the outflow pressure of the oil from the ejection part 34 to be increased.

In addition to the above-described configuration, as shown in FIGS. 5 and 6, the oil guide 3A has a plurality of insertion claws 38 which are to be inserted into the inflow ports of the in-core flow paths 22 to position the oil guide 3A with respect to the stator core 2. The insertion claws 38 are each a projection protruding axially inward from the axially inner part of the oil guide 3A and are arranged on circumferentially both sides of one first connector 35 of two successively aligned first connectors 35. Thus, the oil guide 3A is provided with the insertion claws 38, and therefore, the oil guide 3A can be positioned with respect to the stator core 2 with a simple configuration.

The ejection parts 34 and the sub-ejection parts 37 are each configured to eject the oil toward the coil end 40, wherein these parts are configured such that the oil is applied to individual coil ends 40. More specifically, the ejection parts 34 and the sub-ejection parts 37 are configured such that different coil ends 40 are their respective ejection targets, that is, the ejection parts 34 and the sub-ejection parts 37 are configured to eject the oil toward respective ones of the coil ends 40. Thus, the oil is applied to each of the coil ends 40, and thus, the entirety of the coils 4 can be more efficiently cooled.

Further, the ejection parts 34 and the sub-ejection parts 37 are configured as described in further detail below so that the oil is ejected appropriately to the arrangement and the shape of each of the coil ends 40 which are the ejection targets.

### Ejection Manner of Ejection Part and Sub-Ejection Part

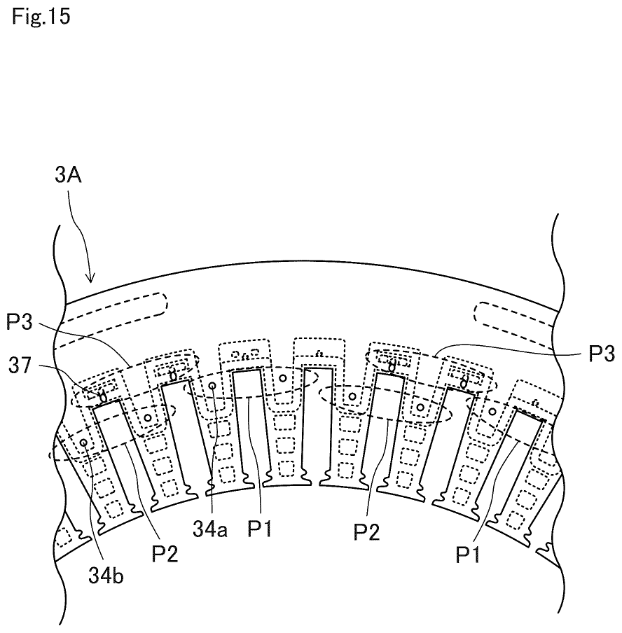

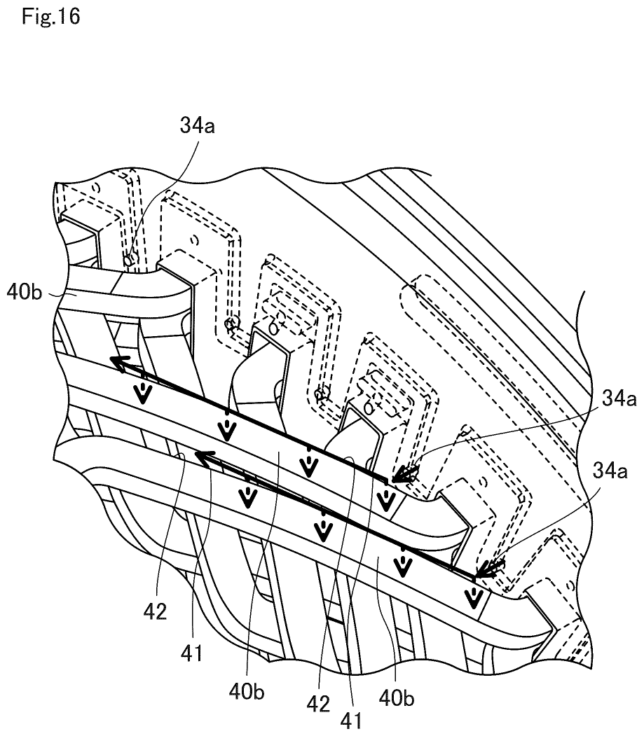

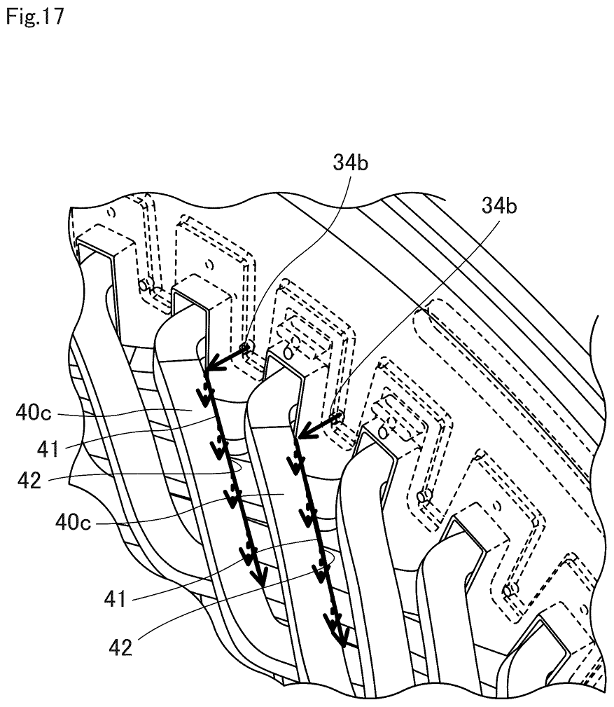

FIG. 15 is a view for explaining an ejection manner of the ejection parts 34 and the sub-ejection parts 37. FIG. 16 is an enlarged view of the ejection parts 34a on a radially outside and the coil ends 40b which are ejection targets of the ejection parts 34a. Note that in FIG. 16, the coil ends 40a radially outward of and overlapping the coil ends 40b is omitted for the sake of illustration. FIG. 17 is an enlarged view of the ejection parts 34b on radially inside and the coil ends 40c which are ejection targets of the ejection parts 34b. Note that for the sake of illustration, the coil ends 40b radially outward of and overlapping the coil ends 40c and the coil ends 40a radially outward of and overlapping the coil ends 40b are omitted in FIG. 17.

As an example of the ejection manner, the ejection targets of the ejection parts 34a (ejection parts on the radially outside) indicated by being surrounded by an ellipse P1 of FIG. 15 are the coil ends 40b shown in FIG. 16, and the ejection parts 34a are configured to eject the oil toward the inside parts 42 facing the oil guide 3A at the tilted parts 41 of the coil ends 40b. Similarly, the ejection targets of the ejection parts 34b (ejection parts on the radially inside) indicated by being surrounded by an ellipse P2 of FIG. 15 are the coil ends 40c, shown in FIG. 17, radially inward of and overlapping the coil ends 40b, and the ejection parts 34b are configured to eject the oil toward the inside parts 42, facing the oil guide 3A, of the tilted parts 41 of the coil ends 40c.

The ejection parts 34a and 34b having the above-described configuration eject the oil toward the inside parts 42 of the tilted parts 41 of the coil ends 40b and 40c, that is, parts in the proximity of the oil guide 3A. Thus, the oil can be reliably applied to the coil ends 40b and 40c. Further, as an accompanying effect, when the oil is applied to the tilted parts 41 of the coil ends 40b and 40c, the oil moves axially outward along the tilted parts 41, thereby more efficiently cooling the coil ends 40b and 40c.

Further, as shown in FIGS. 16 and 17, the ejection parts 34a and 34b are, in particular, configured to eject the oil radially outward of the coil ends 40b and 40c. Thus, at the coil ends 40b and 40c arranged on a side corresponding to the 12 o'clock side (an upper side) of the oil guide 3A, that is, the coil ends 40b and 40c arranged on the upper side of the oil guide 3A, the oil moves downward along the coil ends 40b and 40c due to its self-weight, thereby more efficiently cooling the coil ends 40b and 40c.

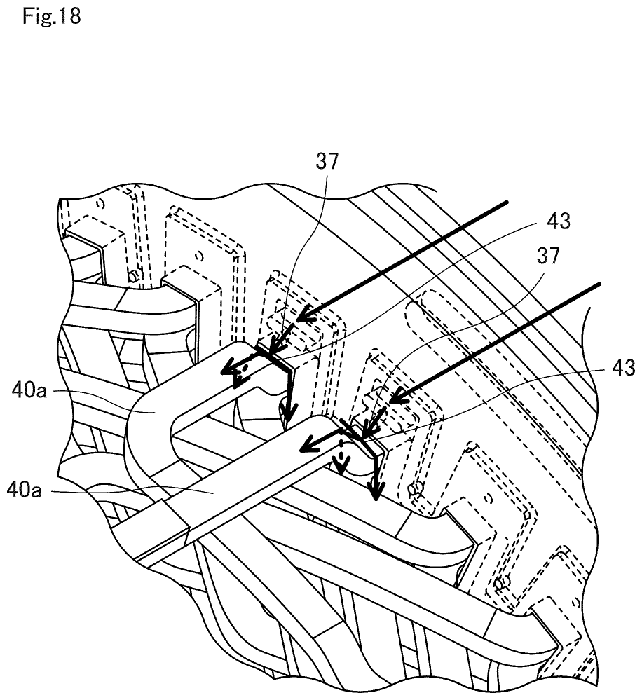

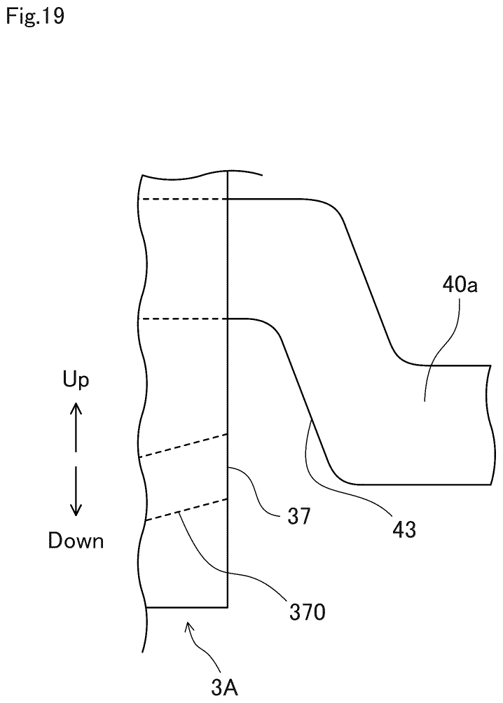

FIG. 18 is an enlarged view of the sub-ejection parts 37 and the coil ends 40a which are ejection targets of the sub-ejection parts 37. FIG. 19 is a schematic longitudinal sectional view of the coil end 40a arranged on a lower side of the oil guide 3A and peripheral parts of the coil end 40a. In addition to the examples described above, the ejection targets of the sub-ejection parts 37 indicated by being surrounded by an ellipse P3 of FIG. 15 are the coil ends 40a shown in FIG. 18, and the sub-ejection parts 37 are configured to eject the oil radially inward from radially outside the coil ends 40. More specifically, as shown in FIG. 19, each flow path 370 leading to a corresponding one of the sub-ejection parts 37 is tilted radially inward (in FIG. 19, upward) toward the corresponding one of the sub-ejection parts 37.

The sub-ejection parts 37 having the above-described configuration eject the oil radially inward toward the step parts 43 of the coil ends 40a present radially inside the sub-ejection parts 37. In particular, as shown in FIG. 19, toward the coil ends 40a arranged on a side corresponding to the 6 o'clock side (a lower side) of the oil guide 3A, that is, the stepped parts 43 of the coil ends 40a located upward of the sub-ejection parts 37, the oil is ejected upward against the gravity. Thus, the oil can reliably be applied to the coil ends 40a located radially inside the sub-ejection parts 37.

Note that although illustration is omitted, some of the ejection parts 34 may be configured to eject the oil radially inward from radially outside the coil ends 40 in a similar manner to the sub-ejection parts 37, and also in this case, the oil can be reliably applied to the coil ends 40 located radially inside the ejection parts 34 in a similar manner to the above-explained case.

### Configuration of Housing

Referring back to FIG. 1, the housing 9 includes: a body part 91 having a circularly cylindrical shape; and a pair of lids 92 each of which has a bottomed circularly cylindrical shape and which are arranged to close respective openings on axial ends of the body part 91. The bottom of each lid 92 has a hole 920 into which the shaft 10 is to be inserted. Each lid 92 is fixed to a corresponding one of the axial ends of the body part 91 with a fastener (not shown) such as a bolt.

In a state where each of the lids 92 is fixed to the body part 91, a bottom inner surface 92a of the each of the lids 92 is in contact with the sub-oil guide 5 arranged at the axial end of the stator 12 and presses the sub-oil guide 5 axially inward. In this state, the oil guide 3A arranged axially inside the sub-oil guide 5 is pressed by the lid 92 axially against the stator core 2 via the sub-oil guide 5. That is, the housing 9 is configured to press the oil guide 3A of the stator 12 axially against the stator core 2. With the housing 9 having the above-described configuration, the oil is suppressed from leaking from a location between the stator core 2 and the oil guide 3A without providing a sealing member, such as an O-ring, between the stator core 2 and the oil guide 3A. This can reduce the number of components included in the motor unit A, thereby reducing the cost of the motor unit A.

With the stator 12 described above, the oil guide 3A provided with the introduction part 33A and the ejection parts 34 provides the effect that the externally supplied oil is ejected onto the coil ends 40 in a fresh state, a state where the externally supplied oil has not drawn heat from another component of the stator 12, and thus, the coils 4 can be efficiently cooled.

Further, an accompanying effect in addition to the above effect is that configuring the oil guide 3A as a component separate from the stator core 2 enables the oil guide 3A to be provided for the stator 12 without influencing the strength and/or the manufacturability of the stator core 2.

Further, as described above, the oil guide 3A is made of resin material, and thereby, the degree of freedom of processing the oil guide 3A can be increased, and therefore, the arrangement and the shape of the ejection parts 34 can be freely set such that the oil is ejected in accordance with the attachment posture of the coils 4 to the stator core 2 and the oil guide 3A, more specifically, in a manner appropriate to the arrangement and/or the shape of the coil ends 40 being the ejection targets.

Moreover, as described above, the sub-oil guide 5 has the guide groove 50, and therefore, the externally supplied oil is guided along the guide groove 50 formed in the outer circumference part 5p of the sub-oil guide 5 to the introduction part 33A of the oil guide 3A. Thus, without increasing the size of the stator 12 radially outward beyond the oil guide 3A, the externally supplied oil can be guided to the introduction part 33A, and thus, the oil can be introduced to the introduction part 33A with a simple and space-saving structure.

Note that liquid other than the oil may be employed as the cooling medium. Moreover, the oil guide 3A may be provided at least at an axially one end of the stator core 2. Also in this case, the effect is that the coils 4 can be efficiently cooled in a similar manner to the above-explained case. Moreover, the oil guides 3F and 3R may have shapes different from each other.

Note that the oil guide 3A may be made of non-magnetic material, such as ceramics, other than resin material. Making the oil guide 3A of non-magnetic material allows the oil guide 3A to be provided for the stator 12 without magnetically influencing the motor 1.

Note that one sub-oil guide 5 may be provided on one side in the axial direction in accordance with the shape of the oil guide 3A and/or the entire layout of the motor 1 including the stator 12, or no sub-oil guide 5 may be provided.

Note that the arrangement and/or the shape of the ejection parts 34 and the sub-ejection parts 37 are not limited to the above-described examples but may be accordingly set such that the oil is ejected in accordance with the attachment posture of the coils 4 to the stator core 2 and the oil guide 3A, more specifically, in a manner appropriate to the arrangement and/or the shape of the coil ends 40 being the ejection targets. For example, some of the ejection parts 34 may be arranged radially outside the coil ends 40, and some of the remaining of the ejection parts 34 may each be arranged between adjacent ones of the second slots 30, and/or the sub-ejection parts 37 may each be arranged between adjacent ones of the second slots 30.

Moreover, the ejection part 34 and the sub-ejection part 37 may be configured such that an identical coil end 40 is their ejection target, that is, the ejection part 34 and the sub-ejection part 37 may be configured to eject the oil toward an identical coil end 40. Alternatively, the ejection part 34 and the sub-ejection part 37 may be configured such that two or more coil ends 40 are their ejection targets, that is, the ejection part 34 and the sub-ejection part 37 may be configured to eject the oil toward two or more coil ends 40.

Note that it is sufficient that the sub-ejection parts 37 are configured to eject the oil flowing from an oil guide on one side toward the coil ends 40 on the other side as in the second flow pattern and the third flow pattern, and thus, the sub-ejection parts 37 may be provided at least for an oil guide on the other side (in the second flow pattern, the rear oil guide 3R, and in the third flow pattern, the front oil guide 3F).

Note that the attachment posture of the coils 4 to the stator core 2 and the oil guide 3A is not limited to the example described above but may accordingly be set in accordance with the shape of the stator core 2 and the oil guide 3A. Moreover, the coils 4 are not limited to the example described above but may be a continuous winding other than the SC windings.

### Second Embodiment

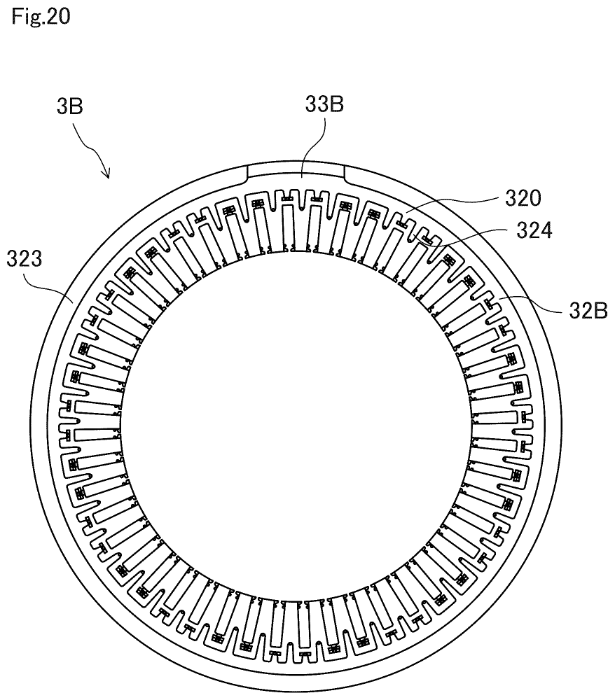

FIG. 20 is a schematic front view of an oil guide 3B of a second embodiment. Next, a difference of the configuration of the oil guide 3B of the second embodiment of the present disclosure from the oil guide 3A of the first embodiment will mainly be described.

As shown in FIG. 20, the oil guide 3B of the second embodiment may be provided with a peripheral wall 323 continuously surrounding an annular part 320 from radially outside. Here, “continuously” does not necessarily mean the entire circumference (i.e., 360 degrees) but is a concept including the case where the circumference is partially interrupted by less than about 30 degrees as shown in FIG. 20. An upper part of the peripheral wall 323 is interrupted, and the interrupted part is an introduction part 33B of the second embodiment. With the peripheral wall 323, a space radially outside the annular part 320 is occupied by the peripheral wall 323, thereby reducing the volume of a flow path in the oil guide 3B. This can suppress air from accumulating in the oil guide 3B, thereby suppressing the ejection pressure of the oil from the oil guide 3B from decreasing.

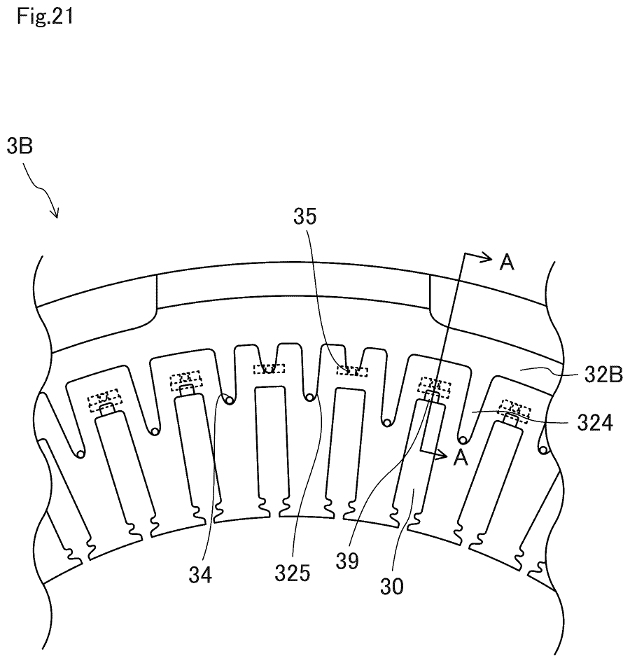

FIG. 21 is an enlarged view of an upper part of the oil guide 3B of FIG. 20. As shown in FIG. 21, branches 324 of the second embodiment are each connected to an ejection part 34 or a first connector 35. A terminal part 325 which is a radially inside end of each branch 324 is rounded, and a terminal edge of the terminal part 325 of each branch 324 connected to the ejection part 34 is tangent to a terminal edge of the ejection part 34. Thus, a chamber 32B of the second embodiment is connected to the ejection parts 34 at terminal ends of the branches 324. The chamber 32B connected to the ejection parts 34 in such a manner eliminates a space in each branch 324 between an end side and its part connected to a corresponding one of the ejection parts 34. This can suppress air from accumulating at the terminal ends of the branches 324, thereby suppressing the ejection pressure of the oil from the oil guide 3B from decreasing.

Similarly to the case of the ejection parts 34 described above, the chamber 32B of the second embodiment is connected to the first ejection parts 35 at terminal ends of the branches 324. This can suppress air from accumulating at the terminal ends of the branches 324, similarly to the case of the ejection parts 34 described above, thereby suppressing the inflow pressure of the oil to in-core flow paths 22 from decreasing.

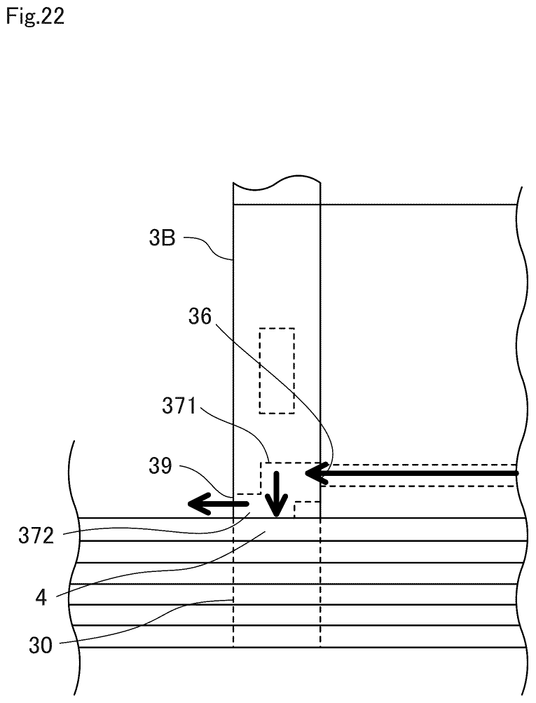

FIG. 22 is a schematic longitudinal sectional view of one of flow paths 371 leading to respective sub-ejection parts 39 of the second embodiment. Specifically, FIG. 22 shows a cross-section along line A-A of FIG. 21. As shown in FIG. 21, the oil guide 3B of the second embodiment is provided with the sub-ejection parts 39 radially outside second slots 30 in a similar manner to the oil guide 3A of the first embodiment, wherein each sub-ejection part 39 of the second embodiment is a rectangular hole and is arranged adjacent to a corresponding one of the second slots 30. As shown in FIG. 22, the flow paths 371 leading to the sub-ejection parts 39 from second connectors 36 have openings 372 which are open toward the second slots 30. With such openings 372, coils 4 inserted through the second slots 30 face the flow paths 371 via the openings 372, thereby increasing a contact area between the oil and the coils 4. More specifically, part of the oil flowing through the flow paths 371 flows through the openings 372 into the second slots 30 and is applied to the coils 4 inserted into the second slots 30. Thus, the coils 4 can be more efficiently cooled.

Note that although illustration is omitted, when the ejection parts 34 are arranged radially outside the second slots 30, flow paths leading to the ejection parts 34 (flow paths leading to the ejection parts 34 and a chamber 32A) may have openings in a similar manner to the flow paths 371. Also in this case, the coils 4 can be more efficiently cooled in a similar manner to the above case.

The embodiments described above are examples in all aspects and should not be construed as limiting. Thus, the technical scope of the present invention should not be interpreted based on only the embodiments and the examples described above but is set forth based on the recitation of the claims. Moreover, modifications and variations belonging to the equivalent of the scope of the claims should all fall within the scope of the present invention.

While the present disclosure has been described with reference to embodiments thereof, it is to be understood that the disclosure is not limited to the embodiments and constructions. The present disclosure is intended to cover various modification examples and modifications within the range of equivalency. In addition, various combinations and configurations, and further, other combinations and configurations including more, less, or only a single element thereof are also within the spirit and scope of the present disclosure.

What is claimed is:

1. A stator comprising:
a stator core having a circularly cylindrical shape;
a guide member having a ring shape and arranged coaxially with the stator core on at least one side in an axial direction of the stator core; and
coils attached to the stator core and the guide member such that a plurality of coil ends of the coils axially protrude from the guide member, wherein
the guide member includes
an introduction part to which a cooling medium which is externally supplied is introduced, and
a plurality of ejection parts which communicate with the introduction part and which are configured to eject the cooling medium toward the plurality of coil ends.

2. The stator of claim 1, wherein
some of the plurality of coil ends have tilted parts each extending obliquely outward in a direction intersecting the axial direction, and
some of the plurality of ejection parts are configured to eject the cooling medium toward inside parts of the tilted parts, the inside parts facing the guide member.

3. The stator of claim 1, wherein
some of the plurality of ejection parts are configured to eject the cooling medium radially inward from radially outside the plurality of coil ends.

4. The stator of claim 1, wherein
the stator core may have a plurality of first slots each of which axially penetrates the stator core and which are aligned side by side circumferentially,
the guide member has a plurality of second slots each of which axially penetrates the guide member such that the plurality of second slots correspond to the plurality of first slots,
the plurality of coil ends axially protrude from the plurality of second slots when the coils are inserted into the plurality of first slots and the plurality of second slots, and
some of the plurality of ejection parts are arranged between adjacent ones of the plurality of second slots.

5. The stator of claim 1, wherein
the plurality of ejection parts are configured to eject the cooling medium toward respective ones of the coil ends.

6. The stator of claim 1, wherein
the stator core has an in-core flow path axially penetrating the stator core, and
the guide member has a core connector which communicates with the introduction part and which is connected to an inflow port of the in-core flow path.

7. The stator of claim 6, wherein
the guide member is a first guide member,
the stator includes a second guide member arranged on an opposite side of the stator core from the first guide member in the axial direction,
the first guide member and the second guide member communicate with each other via the in-core flow path such that the cooling medium passes through the in-core flow path from the first guide member to the second guide member, and
the second guide member is provided with a plurality of sub-ejection parts configured to eject the cooling medium flowing from the first guide member toward coil ends which are in a proximity of the second guide member.

8. The stator of claim 7, wherein
the stator core has a plurality of first slots each axially penetrating the stator core,
the second guide member has a plurality of second slots corresponding, one by one, to the plurality of first slots,
the coils are inserted into the plurality of first slots and the plurality of second slots of the second guide member,
each of the plurality of sub-ejection parts is arranged radially outside the second slots of the second guide member, and
flow paths connected to the plurality of sub-ejection parts have openings which are open toward the plurality of second slots of the second guide member.

9. The stator of claim 1, wherein
the guide member has a chamber including an annular part which is concentric, and
the plurality of ejection parts communicate with the introduction part via the chamber.

10. The stator of claim 9, wherein
the guide member is provided with a peripheral wall continuously surrounding the annular part from radially outside.

11. The stator of claim 9, wherein
the chamber includes a plurality of branches branched radially inward from the annular part, and
the branches have ends connected to the plurality of ejection parts.

12. The stator of claim 1, wherein
the guide member is made of non-magnetic material.

13. The stator of claim 1, wherein
the guide member is made of resin material.

14. The stator of claim 1, further comprising a sub-guide member arranged axially outside the guide member, being coaxial with the guide member, and having a cylindrical shape, wherein
the introduction part of the guide member is open radially outward, and
the sub-guide member has an outer circumference part having a guide groove configured to: receive the cooling medium which is externally supplied; and guide the cooling medium to the introduction part.

15. A motor unit comprising:
a motor including the stator of claim 1; and
a housing in which the stator is housed, wherein
the housing is configured to press the guide member of the stator axially against the stator core.
